(19) United States
(12) Patent Application Publication
(10) Pub. No.: US 2008/0247381 A1
(43) Pub. Date: Oct. 9, 2008

(54) Provisioning of Redundant Sip Proxy Resources

(76) Inventors: Markus Bohm, Munchen (DE); Michael Finkenzeller, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/885,269

(22) PCT Filed: Feb. 21, 2006
(86) PCT No.: PCT/EP06/60144

§ 371 Date: Mar. 25, 2008

(30) Foreign Application Priority Data
Feb. 28, 2005 (DE) 10 2005 009 107.5

(51) Int. Cl. H04L 12/66

(52) U.S. Cl. 370/352

(57) ABSTRACT

A resolution of the address of an SIP proxy in an SIP network, with redundant SIP proxy resources, is provided. To establish a connection in an SIP network, an SIP client typically transmits a request to a DNS server system to obtain an address to gain access to SIP proxy resources. The SIP proxy resources are provided in the form of SIP proxy servers which are part of a peer-to-peer group. Messages are exchanged within the peer-to-peer group via a peer-to-peer protocol in order to communicate responsibilities for SIP domains or user-agent addresses. Adjustable responsibilities are defined within group. The address of the SIP proxy server responsible for the request of the SIP client is made available to the DNS server system so the DNS server system can forward the address to the SIP client so as to allow the SIP client to access the relevant Sip proxy server.

The invention relates to a method for resolving the address of an SIP proxy in an SIP network with provisioning of redundant SIP proxy resources, and to an SIP proxy server and a server system both embodied for implementing a method of said type.

One of the most important current advances in communication networks relates to the further development of conventional data networks—represented foremost by what are termed the IP networks—for the provisioning of realtime services such as, for instance, the transmission of voice and of video and audio information. For the most important data network, namely the internet based on the IP (Internet Protocol) protocol, there are currently basically two major alternatively employable protocols for setting up connections for realtime transmission services. Said protocols are the H.323 and SIP (Session Initiation Protocol) protocol. The SIP protocol was first defined in RFC 2543 of the IETF (Internet Engineering Task Force). Some of the SIP protocol's features essential for understanding the invention are described below.

The following major constituents of an SIP network play a central role in setting up a connection using the SIP protocol. Terminals or terminating points of an SIP network are referred to as user agents. Said user agents usually include an SIP client that can send requests to a server. Also important for the SIP's functioning are what are termed DNS (DNS: Domain Name System) servers required for address resolving. Of central significance alongside these are what are termed the SIP proxies, or SIP proxy servers, which receive SIP requests from a user agent and forward them to another location. Alongside said SIP proxies there are also what are termed registrar servers able to accept SIP registration requests and refresh information about user agents in what are termed location servers, or in other databases.

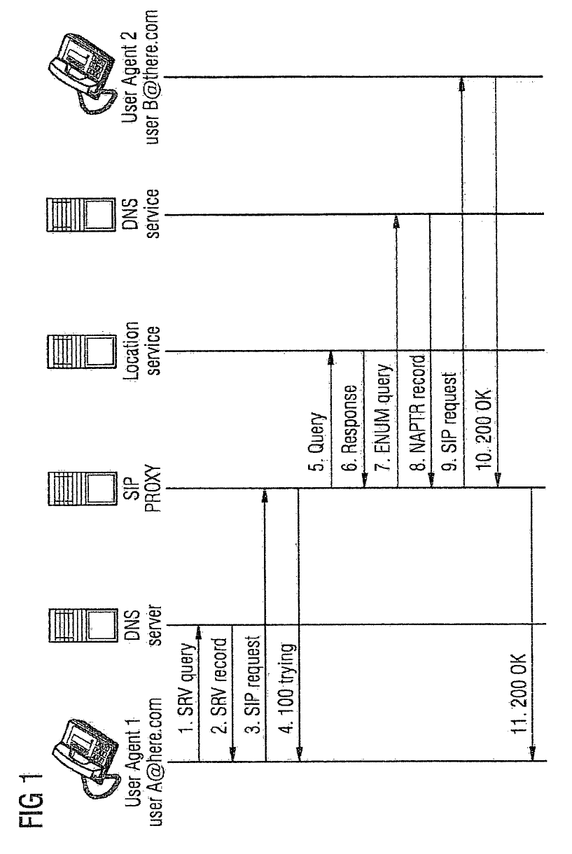

A very major role is played in SIP networks by address resolution. A high degree of mobility and portability is achieved within SIP networks thanks to the address-resolution functions provided by the SIP protocol. A typical address resolution and the role of an SIP proxy are illustrated in more detail below with the aid of FIG. 1. According to said figure, a first SIP terminal user agent 1 is to contact another SIP terminal user agent 2. The address of the other terminal user agent 2 is available to the user agent 1 in the form of an SIP address, for example SIP: UserB@there.com. The user agent must in order to resolve said address first identify a suitable SIP proxy for that function. It directs a query (SRV query or SRV SER query) to a DNS server (step 1). The SIP proxy server responsible for the there.com domain is to be located by means of said query, meaning that the corresponding internet address is to be found. The DNS server then at the second step sends the user agent 1 the internet address of the SIP proxy to be used (SRV record or DNS SRV record). The terminal user-agent 1 can then, using said address, direct a request (SIP request) to the SIP proxy or, as the case may be, proxy server at step 3 for resolving the address of the B-side terminal user agent 2. Said request is acknowledged by the SIP proxy at step 4 by means of the message 100 Trying. At step 5 the SIP proxy directs a request to a location service, which determines the current registration URL (Universal Resource Locator) for the user agent 2 and sends it back at step 6 (response). At step 7 the SIP proxy sends a query to a domain name server (Enum query) in order to obtain the IP address corresponding to the momentarily registered location of the user agent 2. Said address is supplied at step 8 (NAPTR record: DNS Naming Authority Pointer Resource Record; used for ENUM telephone number assignment). The IP address is used at step 9 (SIP request) in order, finally, to contact the user agent 2, which thereupon sends back an acknowledgement (step 10: 200 okay). Said acknowledgement is then forwarded to the user agent 1 (step 11).

The connection setup shown in FIG. 1 is highly simplified. A connection setup in many cases involves more than one SIP proxy server. Nor, as a rule, is address resolution performed by just one domain server but by a (frequently hierarchical) server system. It is therein possible, for example, for a first DNS server to use a commercial (server) service for finding the IP address as is provided by, for instance, DynDNS. It is made clear in FIG. 1 that the SIP proxy server plays a central role. Redundancy or, as the case may be, fault tolerance must be provided for the SIP proxy resources to insure a high degree of availability for the SIP network. The aim therein is to achieve a degree of fault tolerance comparable to that of the conventional PSTN (Public Switched Telephone Network).

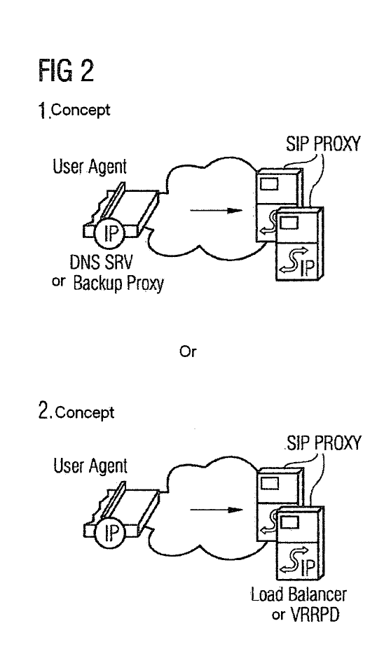

There are various approaches to establishing fault tolerance for SIP proxy resources in an SIP network. Two approaches, or, as the case may be, two concepts are outlined in FIG. 2. In the case of the first concept the user agent will fetch a new or, as the case may be, alternative IP address if contact cannot be established with the SIP proxy (steps 3 and 4 in FIG. 1). That can be implemented by, for example, providing the function of requesting an address for a backup proxy server or, as the case may be, a substitute proxy server for the respective domain (in FIG. 1: there.com) in the user agent. The user agent can in that case repeat steps 1 and 2 again and will then obtain an alternative IP address from the DNS server. Another possibility within the scope of the first concept is to exploit information provided (usually routinely) by the protocol in what is termed the DNS SER record (step 2 in FIG. 1). Said records supply addresses of nearby SIP proxies that accept SIP packets. The SIP proxies made known through a report have been assigned weightings or, as the case may be, priorities. The address of another, alternative SIP proxy can be selected based on said information about SIP proxies. The first of said two possibilities has the disadvantage of resulting practically in a duplication of the SIP proxies, which is a very resource-intensive manner of providing redundancy.

The second procedure has the disadvantage that the user agent needs to be able to analyze and evaluate SER SRV records, meaning it has to be equipped with substantial additional functionalities.

The second approach or, as the case may be, the second concept is to provide redundancy by dynamically assigning the IP address used. For example load balancing is performed through which requests that have been sent to the same IP address are distributed among the various SIP proxy servers (load balancer). Another possibility is to use the Virtual Router Redundancy Protocol (VRRP) described in RFC 2338. A pair of SIP proxy servers is provided in that case, with its being insured by the VRRP protocol that the respective substitute server will assume request processing in the event of an outage. That action will usually be effected with the aid of an VRRP daemon (VRRPD). The latter implementation again has the disadvantage of duplicating the resources, meaning a less efficient use thereof. The use of load balancing exhibits a weakness in the load balancer itself which, being a non-duplicated component, poses a certain risk of disruption (single failure point).

The object of the invention is to disclose an address resolution in an SIP network with SIP proxy redundancy being provided efficiently and non-resource-intensively, with the intention of avoiding the disadvantages of conventional concepts.

Said object is achieved by means of the subject matter of the independent claims.

The central idea underlying the invention is to establish redundancy for SIP proxy resources by providing the SIP proxy resources in the form of a peer-to-peer group of SIP proxy servers. The peer-to-peer concept allows the available SIP proxy servers to be used efficiently for switching services. Some general aspects of peer-to-peer communication are briefly presented below so that the effect and advantages of redundancy provisioning by means of a peer-to-peer group of SIP proxy servers can be better understood.

Peer-to-peer networks being a focal area of much development effort, an array of protocols and concepts for their use already exists. A distinction is as a rule made in terms of the architecture of peer-to-peer networks between three different types. The first peer-to-peer networks were of centralized design. There was a single, central data source to which nodes of the peer-to-peer network could direct inquiries to determine in which of the other nodes the required information or data was kept. Napster is an instance of a peer-to-peer network structure of said type. Because the centrally structured peer-to-peer networks do not readily scale and furthermore pose the risk that the central point may fail, other architectures were developed. A second type are the decentralized but structured peer-to-peer networks. “Structured” therein means there is a topology covering the network. Information should to be made easier to find thanks to said topology. Depending on how strict the constraints imposed by the topology are, it is possible to differentiate such networks in stages ranging from loosely structured up to highly structured. A third type are the decentralized and non-structured peer-to-peer networks where the topology is also absent. For an inquiry aimed at finding information or data, a node of a peer-to-peer network will then contact its neighbor. Making a typical inquiry can consist in, for example, broadcasting an inquiry message, with the inquiry being transmitted to all neighbors within a certain radius. The present invention is preferably realized using structured peer-to-peer networks. Using DHT-based methods (Chord, Pastry, or Kademlia, for example), these can be designed to offer particularly high efficiency and performance where degree of replication and length of search are concerned.

Information can be kept redundantly in peer-to-peer networks (meaning there are copies or replicas). Data or information can therefore be kept in a form distributed over a multiplicity of nodes in the peer-to-peer network, with at least two copies of each unit of information being for increased fault tolerance provided on different nodes. The location for storing information and the frequency of the copies can, depending on the specific type of peer-to-peer network, be optimized for as efficient as possible inquiring. A widespread and efficient method for retrieving information stored in a distributed manner is provided by what is termed the Distributed Hash Table (DHT) system. SIP proxy resources are inventively provided as a (for example decentralized and non-structured) peer-to-peer group of SIP proxy servers. Said peer-to-peer group is responsible for, for instance, the terminals of one or more SIP domains, meaning that said terminals access one of said SIP proxy servers for a connection setup. A plurality of peer-to-peer groups can together form a peer-to-peer network. Information about the responsibility for terminals (SIP clients) in an SIP domain and about functions of the SIP proxy servers can be replicated and stored as a copy. The term “replication group” is used for a group of peers on which information and copies thereof are stored in distributed form. An inventive peer-to-peer group can, though does not have to, correspond to a replication group. Thus, for example, a part of a peer-to-peer group can constitute a replication group, or a replication group can include peers from more than one peer-to-peer group.

The redundant SIP proxy resources can be used for, for exampie, a connection setup via an SIP proxy. For accessing said resources an IP (IP: Internet Protocol) address is made available to an SIP client, for example in response to an inquiry to a DNS server system. Said DNS (Domain Name Server) server system can consist of, for example, a single server. As a rule, though, it will comprise a plurality of possibly hierarchically arranged servers, with its being provided, for example, for one DNS server to access a Domain Name Server service. Said DNS server system is provided with an IP address to be used for, for example, the accessing of SIP proxy resources of the peer-to-peer group by external SIP proxy servers. IP addresses can therein be made known routinely to the DNS server system by the SIP proxy server group. An IP address of said type can alternatively be obtained by the DNS server system in response to a request. Responsibilities for SIP domains or individual user-agent addresses are defined within the peer-to-peer group for the purpose of forwarding an IP address that is to be used. The SIP domains can therein in each case be the SIP domain of the inquiring SIP client or, as the case may be, user agent, or the SIP domain of the user agent to be contacted for a connection setup. Using peer-to-peer protocols for defining responsibilities or, as the case may be, for exchanging information about responsibilities enables dynamic and adaptive assigning of an SIP proxy server to an SIP domain to be implemented reliably. Any changes or influences can be responded to flexibly. For example if a new SIP proxy server is added, if an SIP proxy server suffers an outage or is disconnected, or if the available IP address pool changes, then necessary measures can be communicated or, as the case may be, implemented by means of peer-to-peer protocols. The peer-to-peer group can therein also include at least one registrar server, which will insure that information logged by said registrar server through registering can be forwarded or, as the case may be, made available by peer-to-peer protocols. The SIP proxy servers of the peer-to-peer group are preferably at the same time registrar servers. Registrar and proxy will then merge within a peer-to-peer network into a single instance. That could then be described by saying that the peer-to-peer network consists of generic servers capable of performing the SIP proxy function and the SIP registrar function. A response to an influence can also be an adaptation of or change to one or more replication groups. For example a replication group can be extended to SIP proxy servers of an SIP proxy server group in which no server previously formed part of the replication group. A replication group can also be extended to SIP proxy servers belonging to another replication group or no replication group.

The concept is flexible in terms of incorporating new SIP proxies or restructuring existing SIP proxy resources. For example domain responsibility can be dynamically extended to peers which, for example, previously did not belong to any domain or that can be dispensed with in another domain. Said dynamic extending can be performed by the P2P protocol and follows boundary conditions such as, for example, the degree of replication within a group responsible for an SIP domain. As regards the degree of replication, that can be defined by a minimum and maximum value. A number of peers responsible for a domain can then keep being reduced owing to another domain's needs until a minimum degree of replication has been reached. The redundancy will then, as it were, be distributed across all domains and not permanently assigned to just one.

It is expedient to routinely check the functioning of the SIP proxy servers within the peer-to-peer group using inquiry messages (what are termed hello messages, for example). That will enable the outage of a server to be identified and, in response thereto, the responsibilities for the relevant SIP domains to be reassigned. An assignment of an SIP domain to an SIP proxy server would with routine checking then correspond to a soft state that will be eliminated if not confirmed.

The invention also includes an SIP proxy server and a server system having a multiplicity of SIP proxy servers embodied or, as the case may be, adapted for inventive redundancy provisioning through the organization of SIP proxy servers and a peer-to-peer group. For example protocol means are provided so that communication can take place within the peer-to-peer group using peer-to-peer protocols as well as communication with a DNS server system. Means for a distributed storage of information are also provided in the servers of the peer-toeer group.

According to a development, a first and a second responsibility are defined within the peer-to-peer group for an SIP domain. If the SIP proxy server having the first responsibility suffers an outage, recourse can then be made to that having the second responsibility in order quickly and efficiently to provide a replacement. The first responsibility can then be transferred to another SIP proxy server, thereby creating a new backup situation (rollover fallback).

It is shown below within the scope of an exemplary embodiment how the first and second responsibility can be used by the SIP proxy for quickly provisioning backup SIP proxy resources. A second exemplary embodiment shows an address resolution for different constellations.

FIG. 1 shows a typical connection setup using the SIP protocol,

FIG. 2 shows conventional methods for establishing fault tolerance in terms of the SIP proxy resources,

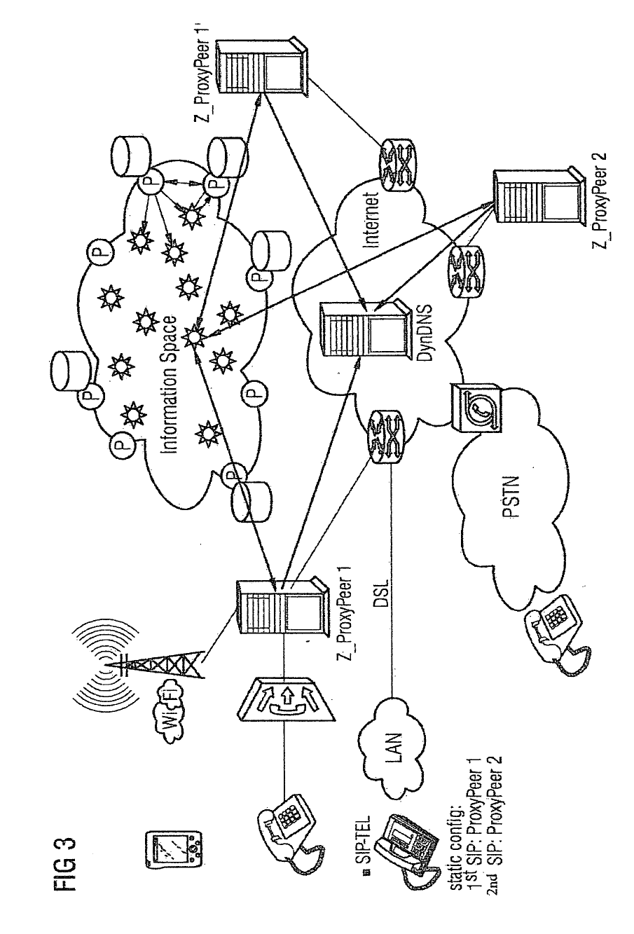

FIG. 3 shows a network scenario wherein a terminal is embodied as a user agent for employing the SIP protocol for setting up a connection,

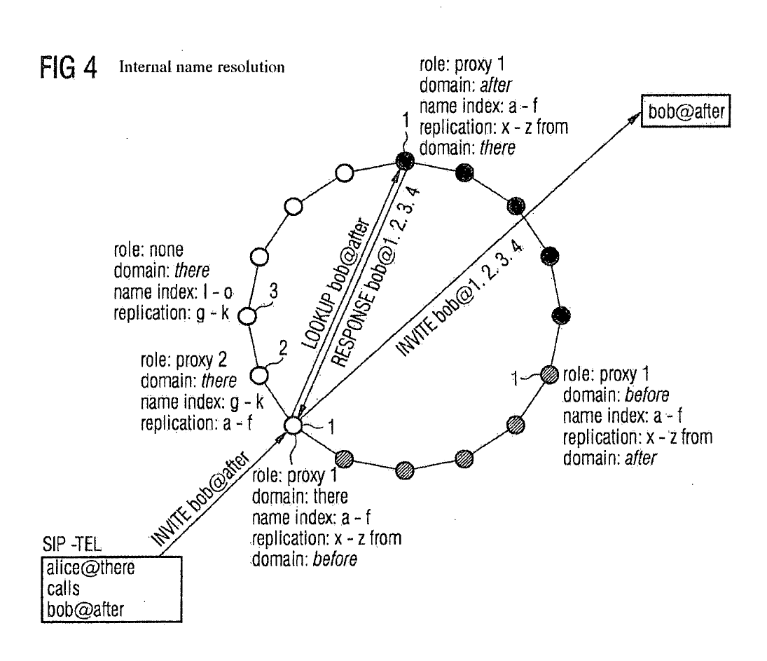

FIG. 4 shows an inventive name resolution within a peer-to-peer network,

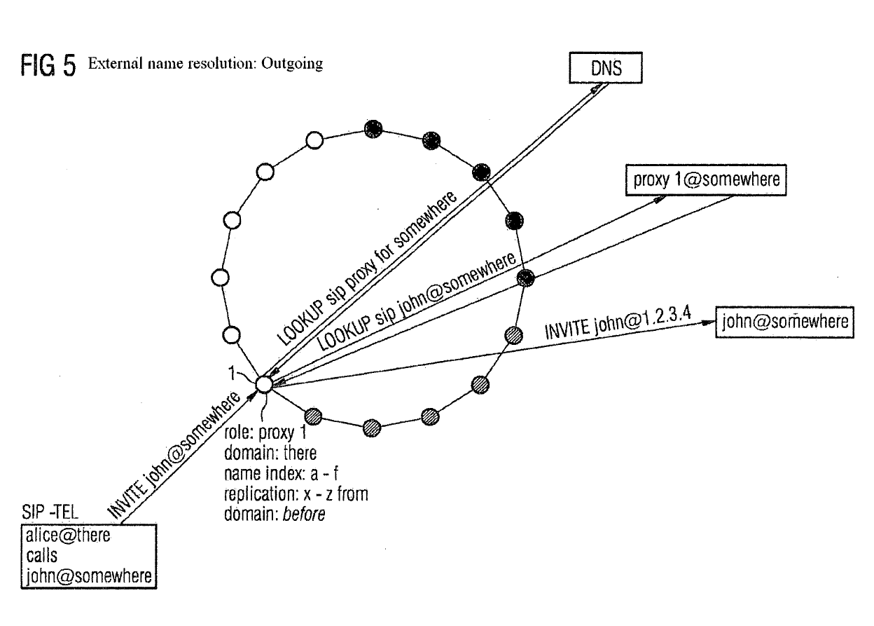

FIG. 5 shows an inventive name resolution for an outgoing call,

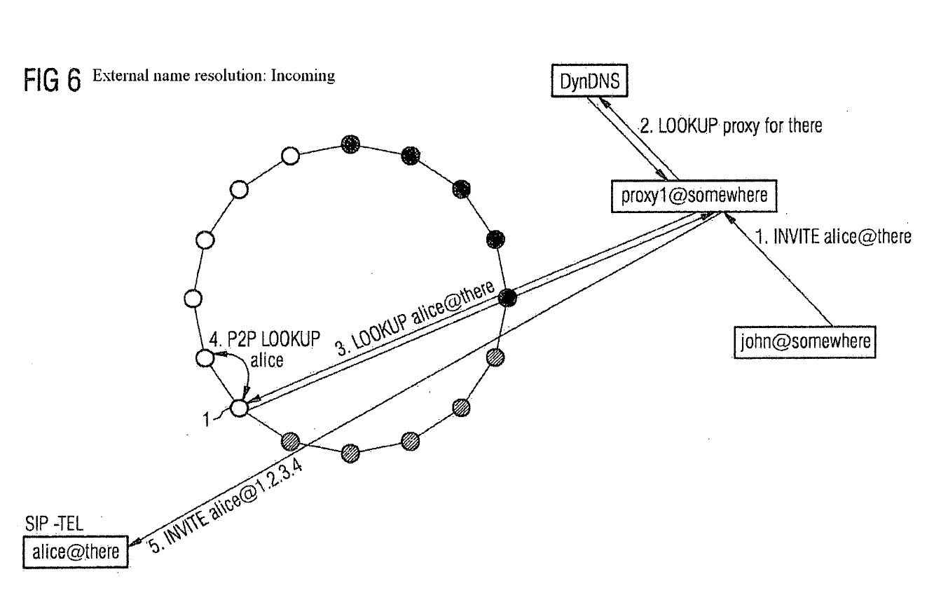

FIG. 6 shows an inventive name resolution for an incoming call, and

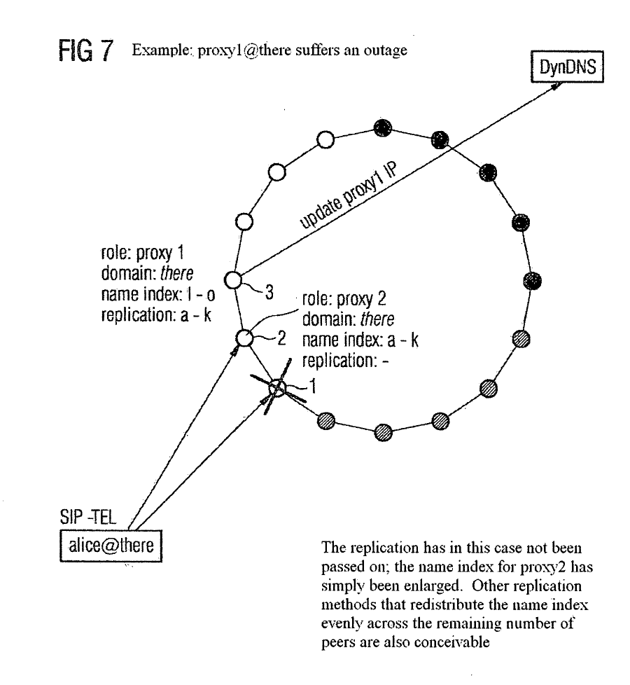

FIG. 7 shows an inventive assumption of functions in the event of an SIP proxy server's having suffered an outage.

In FIG. 3 an SIP telephone (functioning as a user agent) SIP TEL has two statically preconfigured SIP addresses of SIP proxy servers, ProxyPeer1 and ProxyPeer2. For resolving the first configured SIP proxy server address ProxyPeer1, the terminal SIP TEL contacts the DNS server system DynDNS by means of an SRV query message. The DNS server system DynDNS has an assignment of SIP proxy addresses to IP addresses. Said assignment or, as the case may be, address allocation table is routinely communicated to the DNS server system DynDNS by the SIP proxy server group available for the connection setup. The SIP proxy server group includes the proxy servers Z_ProxyPeer1, Z_ProxyPeer2, and Z_ProxyPeer1′. The proxy servers Z_ProxyPeer1, Z_ProxyPeer2, and Z_ProxyPeer1′ therein each have a responsibility for SIP addresses (for example the SIP proxy server Z_ProxyPeer1 has the responsibility for the address ProxyPeer1 and the SIP proxy server Z_ProxyPeer2 has the responsibility for the address ProxyPeer2). The SIP proxy servers are organized as a peer-to-peer server system and notify the DNS server system DynDNS in each case of the current assignments of SIP proxy addresses to the IP address, for example the IP address of the SIP proxy server Z_ProxyPeer1 as being assigned to the SIP proxy address ProxyPeer1 and the IP address of the SIP proxy server Z_ProxyPeer2 as being assigned to the SIP proxy address ProxyPeer2. Any change in the responsibilities of SIP proxy servers can then be communicated to the DNS server system DynDNS simply as a new assignment of an IP address to an SIP proxy address.

The IP addresses of the proxy servers Z_ProxyPeer1 and Z_ProxyPeer2 are currently assigned in the DNS server system DynDNS to the SIP proxy addresses ProxyPeer1 and ProxyPeer2. If one server, for example the SIP proxy server Z_ProxyPeer1, suffers an outage, that fact will be recognized by the peer-to-peer group. For example the IP address of the proxy peer server ProxyPeer1′ will then be notified to the server system DynDNS as the IP address assigned to the SIP proxy address ProxyPeer1 (change of responsibility). The user agent SIP TEL would then, on resolution of the address ProxyPeer1, receive the IP address of Z_ProxyPeer1′ so that said agent will be able to initiate the service, for example connection setup, via said proxy server. If a server, for example the server Z_ProxyPeer1, suffers an outage resulting in a failed contact attempt by the user agent SIP TEL, then the substitute address ProxyPeer2 can be used. For example the user agent SIP TEL has in response to its address-resolution request received the IP address of the proxy server Z_ProxyPeer1. The connection setup (by means of an SIP request) to said SIP proxy server Z_ProxyPeer1 fails, though, because said server has just suffered an outage, meaning that the confirmation message 100 Trying is not received by the user agent SIP TEL. Said agent can then, after a period of time (for example on expiration of a timer), send a query (SRV query) to the DNS server system DynDNS for resolving the SIP proxy address ProxyPeer2, whereupon the DNS server system DynDNS sends back the IP address of the SIP proxy server Z_ProxyPeer2 so that the terminal SIP TEL can realize the connection setup via the SIP proxy server Z_ProxyPeer2.

As is made clear by the above exemplary embodiment, the invention allows dynamic and flexible proxy-resource provisioning that owes its advantages to the SIP proxy servers' being organized as a peer-to-peer group. Exploiting the properties of the SIP proxy system organized as a peer-to-peer network is not restricted to the specific embodiment shown. For example there could also be an assignment in the DNS server system DynDNS of an SIP proxy address or SIP domain (the IP address requiring to be notified will then be determined from the specific SIP domain to which the address of the user agent SIP TEL belongs) to two IP addresses (one regular and one substitute address). The DNS server system DynDNS could, for example, note queries from user agents and, if a second query follows shortly after a first query, send back the respectively other IP address or, as the case may be, substitute address.

The advantages of the inventive concept in terms of name resolution and redundancy provisioning are illustrated below with the aid of FIG. 4 to FIG. 7. FIG. 4 to FIG. 7 show a peer-to-peer network formed by the SIP proxy servers represented as circles. Redundant SIP proxy resources are therein made available by the peer-to-peer network for the three SIP domains there, before, and after. The SIP proxy servers shown as open circles have responsibility for the SIP domain there, the gray circles have responsibility for the SIP domain before, and the black circles have responsibility for the SIP domain after. It is assumed that the terminals belonging to the SIP domains are indexed according to the initial letter of the name and are assigned to the SIP proxy servers for the purpose of storing the information (location, IP address, . . . ) of relevance for contacting. The SIP proxy server 1 therein, as shown in FIG. 4, stores in each case the information for the initial letters a to f. The SIP proxy server 2 for the domain there stores the information for the initial letters g to k, and the SIP proxy server 3 for the domain there stores the information for the initial letters l to o. The information for all connected terminals about the SIP proxy servers responsible for the respective SIP domain is stored in that way. For each of said stored items of information there is a copy that is in each case filed on another SIP proxy server. For example the SIP proxy server 1 for the domain there stores the information for the initial letters x to z of the terminals in the domain before, the SIP proxy server 2 for the domain there stores the information for the initial letters a to f of the terminals in the domain there (which is to say it replicates the information on the SIP proxy server 1 for the domain there), etc. Replicating of the information takes place within the annularly embodied peer-to-peer network in such a way that in each case an adjacent SIP proxy server stores the replicated information for each SIP proxy server. It would alternatively be conceivable to store the replicated information in such a way that no replicated information is stored for another SIP domain (as, for example, in FIG. 1 in the case of SIP proxy server 1). In each case two of the SIP proxy servers responsible for an SIP domain perform the role already described with the aid of FIG. 3, which is to say their SIP addresses (ProxyPeer1 and ProxyPeer2 in FIG. 3) have been preconfigured in the domain's terminals or, as the case may be, preset. Said role or function is identified in figures FIG. 4 to FIG. 7 by proxy1 or, as the case may be, proxy2. Said function is performed for the domain there in figures FIG. 4 to FIG. 7 by the SIP proxy servers 1 and 2. Shown in figures FIG. 4 to FIG. 6 are flows for different constellations for a call setup between alice@there and a second terminal. alice@there therein corresponds to, for example, the SIP client (SIP telephone) SIP TEL shown in FIG. 3.

In FIG. 4 the SIP client alice@there calls the terminal bob@after in the SIP domain after (name resolution within the peer-to-peer network). alice@there for that purpose sends an INVITE message to the SIP proxy server having the function proxy1 for the domain there (which is to say to the SIP proxy server 1 responsible for the domain there). For name resolving, said server contacts the SIP proxy server having the function proxy1 for the domain after (which is to say the SIP proxy server 1 responsible for the domain after) by means of a LOOKUP message. The corresponding IP address bob@1.2.3.4 is sent back in a RESPONSE message. The SIP proxy server 1 of the domain there can thereupon send an INVITE message to the address bob@1.2.3.4, which is to say to bob@after.

In FIG. 5 the SIP client alice@there calls the terminal john@somewhere in the SIP domain somewhere (name resolution for a call to a terminal outside the peer-to-peer network). The SIP domain somewhere is not administered within the peer-to-peer network. alice@there first, as in the case of FIG. 4, sends an INVITE message to the SIP proxy server having the function proxy1 for the domain there. For name resolving, said SIP proxy server having the function proxy1 for the domain there contacts a DNS system by means of a LOOKUP message in order to identify the SIP proxy server responsible for the domain somewhere. A LOOKUP message is then sent to said SIP proxy server responsible for the domain somewhere in order to obtain the IP address of john@somewhere. An INVITE message and the IP address john@1.2.3.4 of john@somewhere are finally sent.

In FIG. 6 the SIP client john@somewhere calls the terminal alice@there (name resolution for a call from a terminal outside the peer-to-peer network). The SIP client john@somewhere first sends an INVITE message to the SIP proxy server proxy1@somewhere responsible for the domain somewhere. Said server sends a LOOKUP message to the DNS System DynDNS in order to identify the SIP proxy server for the domain there. The DNS system DynDNS has stored as the SIP proxy server responsible for the domain there the SIP proxy server of the domain there having the function proxy1. The IP address of alice@there is obtained from said SIP proxy server (SIP proxy server 1) by means of a LOOKUP message. A P2P LOOKUP query will be sent to the relevant peer if the SIP proxy server 1 is not administering the relevant name space. The SIP proxy server proxy1@somewhere finally sends an INVITE message to the IP address alice@1.2.3.4 of alice@there.

FIG. 7 shows the transfer of the function proxy1 in the event of an outage of the SIP proxy server 1 having the function proxy1 of the domain there. If the SIP proxy server having the function proxy1 is unavailable, the terminal SIP TEL can use the SIP proxy server 2 having the function proxy2 for the call setup. The responsibilities of the SIP proxy server suffering an outage will be redistributed once that has been detected by the peers. In the present case the SIP proxy server 3 will assume the function proxy1 and the SIP proxy server 2 will assume responsibility for the terminals (name index a-k instead of, previously, g-k). The SIP proxy server 3 will then store the replicated information of the SIP proxy server 1 (replication a-k).

1.-21. (canceled)

22. A method for resolving the address of an SIP proxy in an SIP network with provisioning of redundant SIP proxy resources, comprising:
providing SIP proxy resources in the form of a plurality of SIP proxy servers, wherein the SIP proxy resources are accessible by a first SIP client;
organizing the SIP proxy servers in a peer-to-peer group forming a peer-to-peer network, the peer-to-peer network having responsibility for the first SIP client;
exchanging messages within the peer-to-peer group via a peer-to-peer protocol, through which responsibilities for SIP domains or user agent addresses are made known; and
performing an address resolution within the peer-to-peer network for a connection setup between the first SIP client and a second SIP client when the peer-to-peer network has responsibility for the first SIP client.

23. The method as claimed in claim 22,
wherein the peer-to-peer network includes a first proxy server responsible for the first client and a second proxy server responsible for the second client, and
wherein the address resolution includes:
sending a request for an IP address of the second client from the first proxy server to the second proxy server, and
receiving a response by the first proxy server from the second proxy server, the response having the IP address of the second client.

24. The method as claimed in claim 22, further comprising:
performing an address resolution for an IP address of a SIP proxy outside of the peer-to-peer network via a DNS server system for a connection setup between a first SIP client and a second client when peer-to-peer network is not responsible for the second client.

25. The method as claimed in claim 22, further comprising:
wherein the peer-to-peer network includes a first proxy server responsible for the first client, and
wherein the address resolution for an IP address of the SIP proxy server outside of the peer-to-peer network includes:
sending a request for the IP address of the SIP proxy server outside of the peer-to-peer network from the first proxy server to a DNS server,
receiving a response by the first proxy server from the DNS server, the response having the IP address of the SIP proxy server outside of the peer-to-peer network,
sending a request for an IP address of the second client from the first proxy server to proxy server outside of the peer-to-peer network, and
receiving a response by the first proxy server from the proxy server outside of the peer-to-peer network, the response having the IP address of the second client.

26. The method as claimed in claim 22, wherein a replication group is provided within the peer-to-peer network.

27. The method as claimed in claim 26, wherein information relating to responsibilities of SIP proxy servers for SIP domains and the respective IP addresses are kept in the peer-to-peer group on a distributed and redundant basis.

28. The method as claimed in claim 27, wherein information relating to responsibilities of SIP proxy servers for SIP domains and the respective IP addresses are determined via a Distributed Hash Table method.

29. The method as claimed in claim 27,
wherein affected responsibilities and IP addresses of SIP proxy servers will be adapted for SIP domains or user-agent addresses in the event of any change affecting the peer-to-peer group, and
wherein at least one replication group will be adapted in the event of any change affecting the peer-to-peer group.

30. The method as claimed in claim 29, wherein the change affecting the peer-to-peer group is due to adding a new SIP proxy server, the outage or disconnection of an SIP proxy server of the peer-to-peer group, or a change relating to the pool of IP addresses available to the peer-to-peer group.

31. The method as claimed in claim 22, wherein the functioning of the SIP proxy servers of the peer-to-peer group is routinely checked via the exchange of messages.

32. The method as claimed in claim 22, wherein the peer-to-peer group includes at least one registrar server.

33. The method as claimed in claim 22, wherein the peer-to-peer servers of the peer-to-peer group a registrar server function.

34. The method as claimed in claim 22, wherein an SIP proxy server is responsible for an inquiry by an SIP client
when having responsibility for a SIP domain of the SIP client, or
when having responsibility for a SIP domain of an SIP user agent to which a connection is to be set up using the SIP proxy resources.

35. The method as claimed in claim 22,
wherein a DNS server system directs a request to the peer-to-peer group for provisioning the IP address of an SIP proxy server responsible for an inquiry of a SIP client, or
wherein information relating to IP addresses of SIP proxy servers and relating to assignments of the IP addresses is routinely conveyed to a DNS server system by the peer-to-peer group.

36. The method as claimed in claim 22,
wherein the first SIP client includes a first SIP address for accessing SIP proxy resources,
wherein the first SIP address is statically configured, and
wherein a request is conveyed by the first SIP client to a DNS server system in order to obtain an IP address, assigned to the first SIP address, for accessing SIP proxy resources.

37. The method as claimed in claim 36,
wherein the first SIP client includes a second SIP address for accessing SIP proxy resources,
wherein the second SIP address is statically configured, and
wherein a request is conveyed by the first SIP client to a DNS server system in order to obtain an IP address, assigned to the second SIP address, for accessing SIP proxy resources in response to no response from the performing the address resolution by the SIP proxy resource having the first SIP address.

38. The method as claimed in claim 22, wherein one first and one second responsibility are defined within the peer-to-peer group for SIP domains or user agent addresses.

39. The method as claimed in claim 38, wherein a first and a second SIP proxy server are specified for SIP domains in keeping with the first and second responsibility for the address resolution, and in that if the first SIP proxy server is discovered to have suffered an outage or is determined to be unavailable, recourse will be made to the second.

40. The method as claimed in one of claim 39, wherein if an outage of an SIP proxy server having the first responsibility for an SIP domain is detected, a substitute server will be determined that will assume the first responsibility for the SIP domain having the outage.
